(19) United States
(12) Patent Application Publication
(10) Pub. No.: US 2014/0124117 A1
(43) Pub. Date: May 8, 2014

(54) TIRE

(71) Applicant: Sachie Urata, Koganei-shi (JP)

(72) Inventor: Sachie Urata, Koganei-shi (JP)

(73) Assignee: BRIDGESTONE CORPORATION, Chuo-ku, Tokyo (JP)

(21) Appl. No.: 14/122,393

(22) PCT Filed: May 25, 2012
(86) PCT No.: PCT/JP2012/063556

§ 371 Date: Nov. 26, 2013

(30) Foreign Application Priority Data
May 26, 2011 (JP) 2011-118163

(51) Int. Cl. B60C 15/00; B60C 9/18

(52) U.S. Cl. CPC B60C 15/0036; B60C 9/18
USPC 152/535; 152/552

(57) ABSTRACT

A tire 1 comprises one pair of bead cores 12, a carcass layer 20 having a toroidal shape that extends between said one pair of bead cores 12, and a belt layer 40 disposed so as to be adjacent to the carcass layer 20. The carcass layer 20 is folded back to an outside in a tire width direction at the bead core 12. The carcass layer 20 folded back at the bead core 12 is disposed so as to be overlapped in a tread portion 30 having a tire stepping surface. The carcass layer 20 is formed of a plurality of carcass cords 21, each of which has an inclination of 30 degrees or more and 50 degrees or less with respect to a tire circumferential direction.

### TECHNICAL FIELD

The present invention relates to a tire provided with one pair of bead cores and a carcass layer having a toroidal shape that extends between such one pair of bead cores.

### BACKGROUND ART

Conventionally, there is known a tire provided with one pair of bead cores, a carcass layer having a toroidal shape that extends between such one pair of bead cores, a belt layer disposed so as to be adjacent to the carcass layer, and a rubber layer covering the bead cores, the carcass layer, and the belt layer.

The tire is provided with a bead portion having a bead core, a tread portion having a tire stepping surface, a side portion that forms a side face of the tire, and a shoulder portion that extends from the side portion to the tread portion.

Here, there is known a tire in which a carcass layer is disposed so that the carcass layer folded back to the outside in a tire width direction at a bead core is overlapped in the tread portion (for example, Patent Literature 1). In such a tire, weight reduction of the tire is accelerated while a rigidity of the tread portion is maintained, in comparison with a tire in which a plurality of individual carcass layers are overlapped with one another.

### CITATION LIST

### Patent Literature

Patent Literature 1: Japanese Patent Application Publication No. 04-297304

### SUMMARY OF THE INVENTION

However, in the tire set forth above, the rigidity of the tread portion is merely maintained with respect to the tire in which the plurality of individual carcass layers are overlapped with one another. That is, a belt layer is not taken into an account. Therefore, in the tire set forth above, a carcass cord provided in the carcass layer has an inclination of 8 degrees to 12 degrees with respect to a tire circumferential direction.

In recent years, a tire provided with a plurality of belt layers has been provided. In such a tire, a belt layer has a belt cord having a predetermined inclination with respect to the tire circumferential direction. By crossing the cords provided in the plurality of belt layers, a sufficient rigidity is ensured with respect to a shear stress in a tire width direction, and a deformation with respect to a tire radial direction is restrained.

In such a tire as well, reduction of the number of parts is required from the viewpoint of environment conservation, and weight reduction of the tire is also desired. For example, it is considered to eliminate at least one belt layer from among the plurality of belt layers.

However, as in the tire described above, in the case where the inclination of the carcass cord with respect to the tire circumferential direction is 8 degrees to 12 degrees, the rigidity with respect to the shear stress in the tire width direction cannot be ensured by the carcass layer. Therefore, if at least one belt layer is eliminated, the rigidity with respect to the shear stress in the tire width direction becomes insufficient as a whole of the tire.

Accordingly, the present invention has been made in order to solve the problem described above, and it is an object of the present invention to provide a tire that is capable of reducing at least one belt layer of a plurality of belt layers while ensuring a rigidity with respect to a shear stress in a tire width direction.

A tire (tire 1) according to a first feature comprises one pair of bead cores (bead cores 12), a carcass layer (carcass layer 20) having a toroidal shape that extends between said one pair of bead cores, and a belt layer (belt layer 40) disposed so as to be adjacent to the carcass layer. The carcass layer is folded back to an outside in a tire width direction at the bead core. The carcass layer folded back at the bead core is disposed so as to be overlapped in a tread portion (tread portion 30) having a tire stepping surface. The carcass layer is formed of a plurality of carcass cords (carcass cords 21), each of which has an inclination of 30 degrees or more and 50 degrees or less with respect to a tire circumferential direction.

In the first feature, in a direction in which the carcass cords extend, a treat tensile rigidity of the carcass layer is 90 kgf/mm2 or more and 300 kgf/mm2 or less.

In the first feature, in a tire width direction, an overlap width of the carcass layer that is folded back at the bead core is ⅓ or more of a width of the belt layer.

In the first feature, the belt layer has a plurality of belt cords (belt cords 41) extending in the tire circumferential direction. A strength of one belt cord of the plurality of belt cords is larger than a strength of one carcass cord of the plurality of carcass cords.

In the first feature, the belt layer has a plurality of belt cords, each of which has an inclination of −10 degrees or more and 0 degree or less with respect to the tire circumferential direction. In the tire circumferential direction, a treat tensile rigidity of the belt layer is 750 kgf/mm2 or more, and a treat tensile strength per width of 50 mm is 2,100 kgf or more.

In the first feature, the tire has a first belt layer and a second belt layer as the belt layer, the second belt layer being disposed so as to be adjacent to the first belt layer in a tire radial direction. The second belt layer has a plurality of belt cords, each of which has a predetermined inclination with respect to the tire circumferential direction. The first belt layer has a plurality of belt cords, each of which has an inclination that is larger than the predetermined angle with respect to the tire circumferential direction.

According to the present invention, it is possible to provide a tire that is capable of reducing at least one belt layer of a plurality of belt layers while ensuring a rigidity with respect to a shear stress in a tire width direction.

### BRIEF DESCRIPTION OF THE DRAWINGS

FIG. 1 is a perspective view showing a tire 1 according to the first embodiment.

FIG. 2 is a schematic view showing a cross section in a tire width direction of the tire 1 according to the first embodiment.

FIG. 3 is a schematic view when the tire 1 according to the first embodiment is seen from the outside in a tire radial direction.

FIG. 4 is a schematic view showing a cross section in a tire width direction of the tire 1 according to the first modification example.

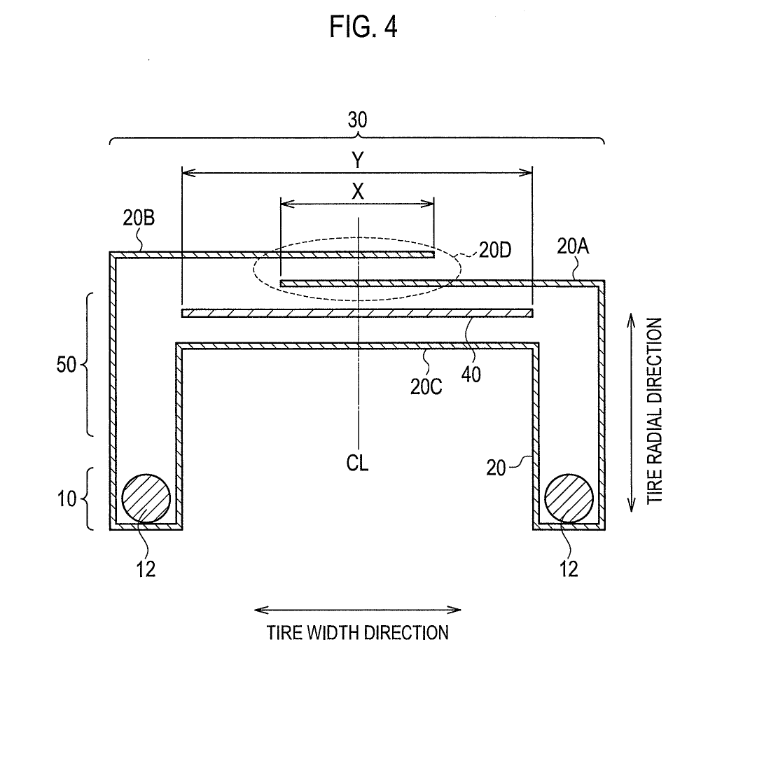

FIG. 5 is a schematic view showing a cross section in a tire width direction of the tire 1 according to the second modification example.

### DESCRIPTION OF THE EMBODIMENT

Hereinafter, the tire according to the embodiment of the present invention will be described. Note that, in the following description of the drawings, the same or similar reference numerals are used to designate the same or similar parts.

It will be appreciated that the drawings are schematically shown and the ratio and the like of each dimension are different from the real ones. Therefore, a specific dimension should be determined in diagram of the following description. Moreover, among the drawings, the respective dimensional relations or ratios may differ.

### Description of Embodiments

A tire according to the embodiments is provided with one pair of bead cores, a carcass layer having a toroidal shape that extends between such one pair of bead cores, and a belt layer disposed so as to be adjacent to the carcass layer. The carcass layer is folded back to the outside in a tire width direction at the bead core. The carcass layer folded back in the bead cores is disposed so as to be overlapped in a tread portion having a tire stepping surface. The carcass layer is formed of a plurality of carcass cords, each of which has an inclination of 30 degrees or more and 50 degrees or less with respect to a tire circumferential direction.

In the embodiment, the inclination of the carcass cord with respect to the tire circumferential direction is 30 degree or more, and thus, a rigidity with respect to a shear stress in the tire width direction can be ensured by the carcass layer. The rigidity with respect to the shear stress is ensured by the carcass layer, and thus, even if at least one belt layer is eliminated from among a plurality of belt layers, the rigidity with respect to the shear stress in the tire width direction is ensured as a whole of the tire.

In the embodiments, the inclination of the carcass cord with respect to the tire circumferential direction is 50 degree or less, and thus, lowering of steering stability is restrained.

### First Embodiment

(Structure of Tire)

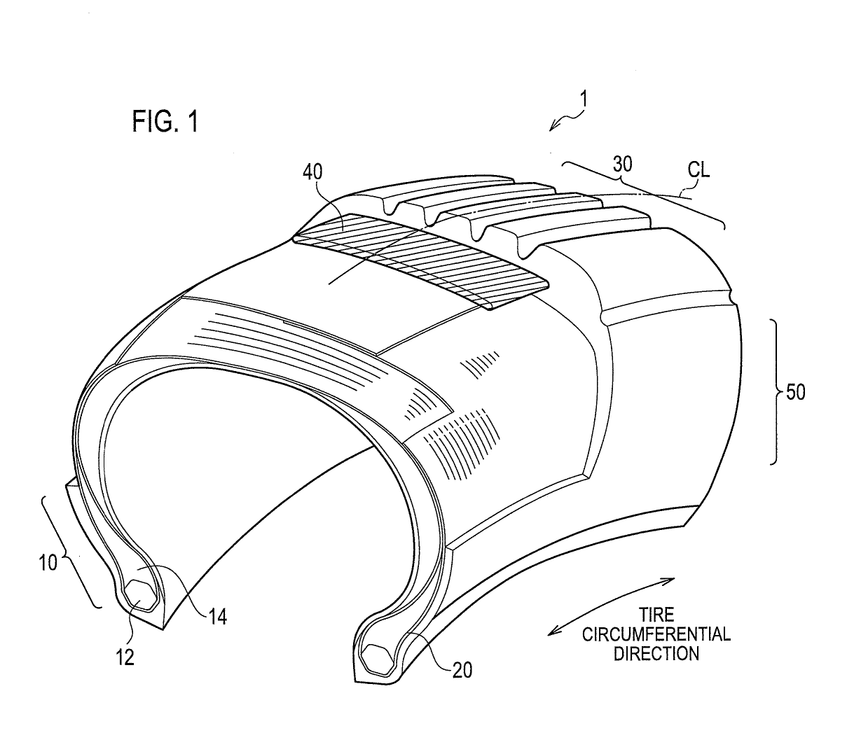

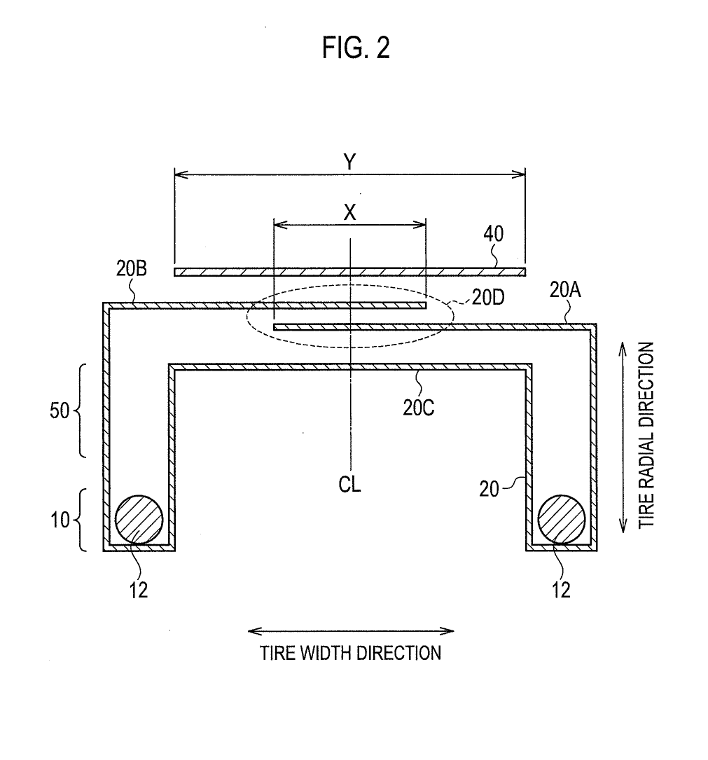

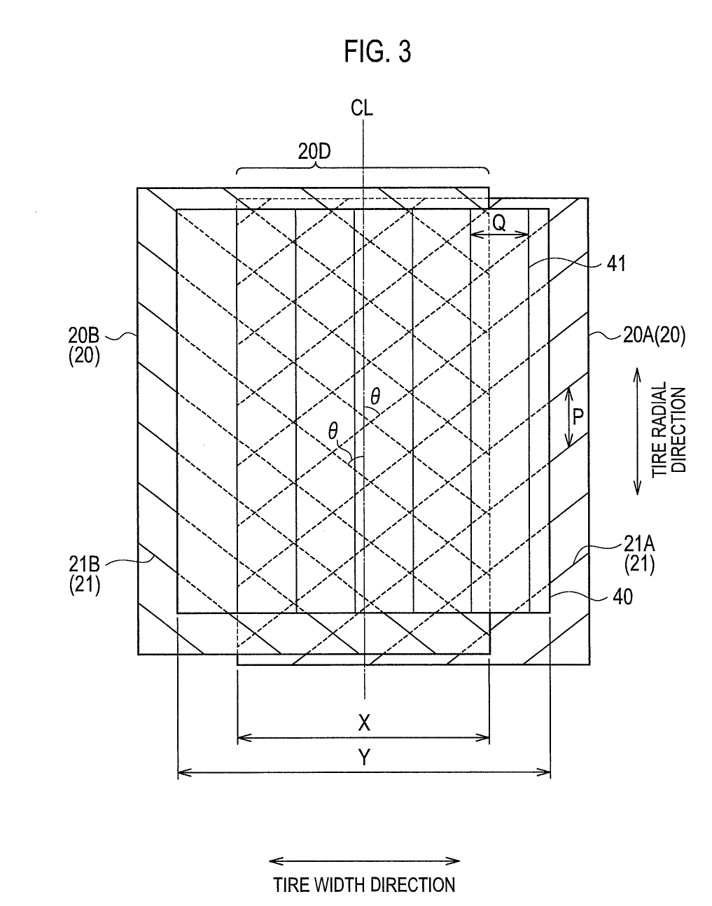

Hereinafter, a tire according to the first embodiment will be described with reference to the drawings. FIG. 1 is a perspective view showing a tire 1 according to the first embodiment. In FIG. 1, it should be kept in mind that a part of the tire 1 is eliminated in order to show an internal structure of the tire 1. FIG. 2 is a schematic view showing a cross section in a tire width direction of the tire 1 according to the first embodiment. FIG. 3 is a schematic view when the tire 1 according to the first embodiment is seen from the outside in a tire radial direction.

As shown in FIG. 1, a pneumatic tire 1 is provided with one pair of bead portions 10, a carcass layer 20, a tread portion 30, a belt layer 40, and a side wall portion 50.

A bead portion 10 has a bard core 12 and a bead filler 14. The bead core 12 is provided in order to fix the tire 1 to a rim (not shown). The bead core 12 is configured by bead wires (not shown). The bead filler 14 is provided in order to enhance a rigidity of the bead portion 10.

First, the carcass layer 20 has a toroidal shape that extends between one pair of bead portions 10. The carcass layer 20, as shown in FIG. 2, is folded back to the outside in the tire width direction. In more detail, the carcass layer 20 is folded back while enveloping the bead core 12 and the bead filler 14. The carcass layer 20 folded back at the bead core 12 is disposed so as to be overlapped in a tread portion 30. In more detail, the carcass layer 20 has an outside carcass layer 20A that is folded back at one bead core 12, an outside carcass layer 20B that is folded back at the other bead core 12, and an inside carcass layer 20C that is positioned at the inside in the tire radial direction or in the tire width direction with respect to the outside carcass later 20A and the outside carcass layer 20B. The outside carcass layer 20A and the outside carcass layer 20B constitute an overlap region 20D in which these two layers are to be overlapped with each other at the tread portion 30.

Here, as shown in FIG. 2 and FIG. 3, in the tire width direction, it is preferable that an overlap width X (a width X of the overlap region 20D) of the carcass layer 20 folded back at the bead core 12 be ⅓ or more of a width Y of a belt layer 40.

Second, the carcass layer 20, as shown in FIG. 3, is formed of a plurality of carcass cords 21, each of which has an inclination θ with respect to the tire circumferential direction (a equator centerline CL). The inclination θ of the carcass cord 21 with respect to the tire circumferential direction is 30 degree or more and 50 degree or less. It should be kept in mind that the carcass cord 21A forming the outside carcass layer 20A and the carcass cord 21B forming the outside carcass layer 20B cross each other in the overlap region 20D.

The carcass cord 21 is configured by an organic fiber such as a PET (Polyethylene Terephthalate) or a nylon. In the cord direction, a treat tensile rigidity of one carcass layer 20 is 90 kgf/mm2 or more and 300 kgf/mm2. It is preferable that a rigidity of one carcass cord 21 be 330 kgf/mm2 or more and 526 kgf/mm2 or less. In addition, it is preferable that the number of spikes of the carcass cord 21 per width of 50 mm be 30 to 65.

Here, the treat tensile rigidity (EL) of the carcass layer 20 in the cord direction of the carcass cord 21l is calculated by the formula of EL=Ef×vf+Em×(1−vf).

In the formula, Ef is a rigidity (Young's modulus) of the carcass cord 21, Em is a rigidity (Young's modulus) of a rubber covering the carcass cord 21, and vf is a percentage of the carcass cord 21 included in unit volume of the carcass cord 21 covered with the rubber (a volume content of the cord).

It is to be noted that vf is calculated by the formula of vf=(πr2/4×N)/(r×50). In the formula, r is a radius of the carcass cord 21.

Turning to FIG. 1, the tread portion 30 has a tire stepping surface. The tread portion 30 is configured by a plurality of blocks divided by a circumferential groove or a widthwise groove.

The belt layer 40 is positioned at the outside in the tire radial direction with respect to the carcass layer 20 (the outside carcass layer 20A and the outside carcass layer 20B). In addition, the belt layer 40, as shown in FIG. 3, has a plurality of belt cords 41. The plurality of belt cords 41 each have an inclination of −10 degree or more and 0 degree or less with respect to the tire circumferential direction (the equator centerline CL). It is to be noted that such an angle is defined so that the right turn is the positive direction “+”, and the left turn is the negative direction “−”, with respect to the tire circumferential direction (the equator centerline CL).

A belt cord 41 is configured by a steel or a Kevlar fiber. In the tire circumferential direction, the treat tensile rigidity of the belt layer 40 is 750 kgf/mm2 or more. The treat tensile strength of the belt layer 40 per width of 50 mm is 2,100 kgf or more. It is preferable that the strength of one belt cord 41 be larger than the strength of one carcass cord 21. It is preferable that the rigidity of one belt cord 41 be 526 kgf or more/mm2 or more and the strength of one belt cord 41 be 50 kgf or more. It is preferable that the number of spikes of the belt cord 41 per 50 mm be 30 to 65.

Here, the treat tensile rigidity (EL) of the belt layer 40 in the cord direction is calculated by the formula of EL=Ef×vf×Em×(1−vf).

In the formula, Ef is a rigidity (Young's modulus) of the belt cord 41, Em is a rigidity (Young's modulus) of a rubber covering the belt cord 41, and vf is a percentage of the belt cord 41 included per portion volume of the belt cord 41 covered with the rubber (a volume content of the cord).

It is to be noted that vf is calculated by the formula of vf=(πr2/4×N)/(r×50). In the formula, r is a radius of the belt cord 41.

In addition, the treat tensile rigidity (ET) of the belt layer 40 in an orthogonal direction with respect to the cord direction of the belt cord 41 is calculated by the formula of ET=4/3×Em(1−vf).

Further, a treat tensile rigidity (Exx) of the belt layer 40 in the tire circumferential direction is calculated by Exx=EL cos 4θ+ET. In the formula, θ is an inclination of the belt cord 41 with respect to the tire circumferential direction.

Turning to FIG. 1, a side wall portion 50 is formed at both ends in the tire width direction of the tread portion 30. The side wall portion 50 is positioned between the bead portion 10 and the tread portion 30.

(Operation and Advantageous Effects)

In the first embodiment, the inclination of the carcass cord 21 with respect to the tire circumferential direction is 30 degree or more and 50 degree or less, and thus, the rigidity with respect to the shear stress in the tire width direction can be ensured by the carcass layer 20. The rigidity with respect to the shear stress in the tire width direction is ensured by the carcass layer 20, and thus, even if at least one belt layer is eliminated from among a plurality of belt layers, the rigidity with respect to the shear stress in the tire width direction is ensured as a whole of the tire 1, and lowering of steering stability is restrained.

### MODIFICATION EXAMPLE 1

Hereinafter, Modification Example 1 of the first embodiment will be described with reference to the drawings. Hereinafter, differences from the first embodiment will be mainly described.

Specifically, in the first embodiment, the belt layer 40 is positioned at the outside in the tire radial direction with respect to the carcass layer 20 (the outside carcass layer 20A and the outside carcass layer 20B). On the other hand, in Modification Example 1, the belt layer 40 is positioned at the inside in the tire radial direction with respect to the outside carcass layer 20A and the outside carcass layer 20B, and is positioned at the inside in the tire radial direction with respect to the inside carcass layer 20C.

In Modification Example 1, the belt layer 40 is disposed between the outside carcass layer 20A and the outside carcass layer 20B and the inside carcass layer 20C, and thus, the belt cord 41 provided in the belt layer 40 is protected by the carcass layer 20. Therefore, a cutting durability of the belt cord 41 is improved.

### MODIFICATION EXAMPLE 2

Hereinafter, Modification Example 2 of the first embodiment will be described with reference to the drawings. Hereinafter, differences from the first embodiment will be mainly described.

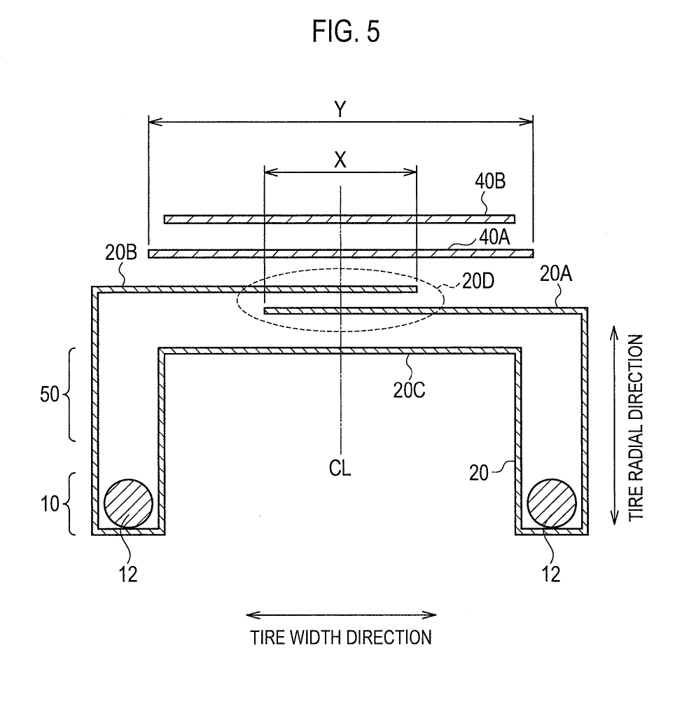

Specifically, in the first embodiment, the belt layer 40 was described by way of example of a case in which the belt layer is made of one layer. On the other hand, in Modification Example 2, a tire, as shown in FIG. 5, has, as a belt layer 40, a first belt layer 40A and a second belt layer 40B that is disposed so as to be adjacent to the first belt layer 40A in a tire radial direction. That is, the belt layer 40 is configured by the first belt layer 40A and the second belt layer 40B. It is to be noted that the second belt layer 40B is disposed at the outside in the tire radial direction with respect to the first belt layer 40A.

The second belt layer 40B has a plurality of belt cords 41B, each of which has an inclination of a predetermined angle with respect to a tire circumferential direction. It is preferable that the predetermined angle be −10 degree or more and 0 degree or less with respect to the tire circumferential direction (the equator centerline CL).

On the other hand, the first belt layer 40A has a plurality of belt cords 41A, each of which has an inclination larger than the predetermined angle with respect to the tire circumferential direction (the equator centerline CL). It is preferable that the plurality of belt cords 41A each have an inclination of 0 degree or more and 80 degree or less with respect to the tire circumferential direction (the equator centerline CL), and it is more preferable that the above belt cords each have an inclination of 10 degree or more and 30 degree or less.

In Modification Example 2, the first belt layer 40A and the second belt layer 40B are provided. The inclination of each of the plurality of belt cords 41A in the first belt layer 40A is larger than the inclination of each of the plurality of belt cords 41B in the second belt layer 40B. Therefore, in Modification Example 2, the rigidity with respect to the shear stress in the tire width direction is ensured by the first belt layer 40A, and thus, the rigidity with respect to the shear stress in the tire width direction is ensured as a whole of the tire 1, and lowering of steering stability is further restrained.

While in Modification Example 2, the second belt layer 40B was described by way of example of a case in which the second belt layer is disposed at the outside in the tire radial direction with respect to the first belt layer 40A, this layer is not limited thereto. The second belt layer 40B may be disposed at the inside in the tire radial direction with respect to the first belt layer 40A.

[Evaluation Result 1]

Hereinafter, Evaluation Result 1 will be described. In Evaluation Result 1, as shown in Table 1, an index evaluation was subjectively made as to the steering stability by means of a cruising test of a vehicle by mounting tires to the vehicle, the tires being different from each other in terms of the inclination of the carcass cord with respect to the tire circumferential direction. It is to be noted that an index 100 is an index of steering stability corresponding to a tire in which the carcass layer is not overlapped in the tread portion and in which no belt layer is eliminated. It is also to be noted that in Examples and Comparative Examples, the tires having a similar structure to that of the embodiment are employed except the values shown in Table 1. In addition, the tire size used is “155/65R13”.

TABLE 1

| | Inclination of | Steering stability |
|---|---|---|
| | carcass cord | Cp (INDEX) |
| Comparative | 60 degrees | 84 |
| Example 11 | | |
| Example 11 | 50 degrees | 95 |
| Example 12 | 40 degrees | 96 |
| Example 13 | 30 degrees | 92 |
| Comparative | 20 degrees | 84 |
| Example 12 | | |

As shown in Table 1, in Example 11 to Example 13, the inclination θ of the carcass cord with respect to the tire circumferential direction is in the range of 30 degree or more and 50 degree or less, and thus, it was verified that lowering of steering stability is restrained. On the other hand, in Comparative Example 11 and Comparative Example 12, the inclination 0 of the carcass cord with respect to the tire circumferential direction is out of the range of 30 degree or more and 50 degree or less, and thus, it was verified that steering stability remarkably lowers.

[Evaluation Result 2]

Hereinafter, Evaluation Result 2 will be described. In Evaluation Result 2, as shown in Table 2, an index evaluation was subjectively made as to the steering stability by means of a cruising test of a vehicle by mounting tires to the vehicle, the tires being different from each other in terms of the treat tensile rigidity of one carcass layer, the rigidity of one carcass cord (the cord rigidity), material for carcass cord, the number of spikes of the carcass cord per width of 50 mm, and diameter of the carcass cord (cord diameter). It is to be noted that the index 100 is an index of steering stability corresponding to the tires in which no carcass layer is overlapped in the tread portion and in which no belt layer is eliminated. It is also to be noted that in Examples and Comparative Examples, the tires having a similar structure to that of the embodiments are employed except the values shown in Table 2. In addition, the tire size used is “155/65R13”.

TABLE 2

| | Treat | | | | | |
|---|---|---|---|---|---|---|
| | tensile | Cord | | Number | Cord | Steering |
| | rigidity | rigidity | | of | diam- | stability |
| | [kgf/ | [kgf/ | | spikes | eter | Cp |
| | mm2] | mm2] | Material | [/50 mm] | [mm] | (INDEX) |
| Comparative | 105 | 200 | PET | 63 | 0.53 | 89 |
| Example 20 | | | | | | |
| Comparative | 69.4 | 526 | PET | 15.8 | 0.53 | 87 |
| Example 21 | | | | | | |
| Comparative | 30 | 526 | PET | 31.5 | 0.53 | 86 |
| Example 22 | | | | | | |
| Example 20 | 90 | 526 | PET | 31.5 | 0.53 | 89 |
| Example 21 | 139 | 526 | PET | 31.5 | 0.53 | 93 |
| Example 22 | 199 | 330 | Nylon | 50.4 | 0.76 | 95 |
| Example 23 | 276 | 526 | PET | 63 | 0.53 | 96 |
| Example 24 | 300 | 200 | PET | 68 | 0.53 | 96 |

As shown in Table 2, first, in Example 20 to Example 24, the treat tensile rigidity of one carcass layer is in the range of 90 kgf/mm2 or more and 300 kgf/mm2 or less, and thus, it was verified that lowering steering stability is restrained. Second, in Example 20 to Example 24, the rigidity of one carcass cord (the cord rigidity) is in the range of 330 kgf/mm2 or more and 526 kgf/mm2 or less, and thus, it was verified that lowering steering stability is restrained. Third, in Example 20 to Example 24, the number of spikes of carcass cord per width of 50 mm is in the range of 30 to 65, and thus, it was verified that lowering steering stability is restrained.

On the other hand, in Comparative Example 21 and Comparative Example 22, the treat tensile rigidity of one carcass layer is out of the range of 90 kgf/mm2 or more and 300 kgf/mm2 or less, and thus, it was verified that steering stability remarkably lowers. Second, in Comparative Example 20, the rigidity of one carcass cord (the cord rigidity) is out of the range of 330 kgf/mm2 or more and 526 kgf/mm2 or less, and thus, it was verified that steering stability remarkably lowers. Third, in Comparative Example 21, the number of spikes of carcass cord per width of 50 mm is out of the range of 30 to 65, and thus, it was verified that steering stability remarkably lowers.

[Evaluation Result 3]

Hereinafter, Evaluation Result 3 will be described. In Evaluation Result 3, as shown in Table 3, there were prepared tires which are different from each other in terms of the treat tensile rigidity of one belt layer, the rigidity of one belt cord (the cord rigidity), the treat tensile strength of belt layer per width of 50 mm, in the strength of one belt cord (the cord strength), the material for belt cord, the number of spikes of belt cord per width of 50 mm, the inclination of belt cord with respect to the tire circumferential direction, and the inclination of the belt cord with respect to the tire circumferential direction. First, the growth percentages of the diameters of the tires (an internal pressure growth @ center) were evaluated in the equator centerlines CL by means of a cruising test of a vehicle by mounting these tires to the vehicle. Second, an index evaluation was subjectively made as to the steering stability by means of the cruising test of the vehicle by mounting these tires to the vehicle. It is to be noted that the index 100 is an index corresponding to the tires in which no carcass layer is overlapped in the tread portion and in which no belt layer is eliminated. In addition, the molding properties and weights of these tires were evaluated. Third, an index evaluation was made as to the fracture strength of the tires by means of a hydraulic pressure test by filling water in these tires. It is also to be noted that the index 100 is an index indicating a predetermined standard such as an in-house standard. It is to be further noted that in Examples and Comparative Examples, the tires having a similar structure to that of the embodiment are employed except the values shown in Table 3. In addition, the tire size used is “155/65R13”.

TABLE 3

| | | | | | | | | Internal | | Fracture |
|---|---|---|---|---|---|---|---|---|---|---|
| | | | Test | | | | | pressure | Steering | strength |
| | Treat tensile | Cord | tensile | Cord | | Number | | growth | stability | hydraulic |
| | rigidity | rigidity | strength | strength | | of spikes | | @center | Cp | pressure |
| | [kgf/mm2] | [kgf/mm2] | [kgf/50 mm] | [kgf/one cord] | Material | [/50 mm] | Angle | [%] | [INDEX] | INDEX |
| Comparative | 276 | 526 | 800 | 16 | PET | 63 | 0 | 7.7 | 87 | 38 |
| Example 31 | | | | | | | | | | |
| Comparative | 455 | 810 | 1088 | 21 | PEN | 51.8 | 0 | 4.3 | 93 | 52 |
| Example 32 | | | | | | | | | | |
| Comparative | 1514 | 2143 | 1500 | 39 | HYBRID | 50 | 0 | 0.6 | 96 | 93 |
| Example 33 | | | | | | | | | | |
| Example 30 | 1514 | 2143 | 2100 | 54 | HYBRID | 50 | 0 | 0.6 | 96 | 130 |
| Example 31 | 1514 | 2143 | 2700 | 54 | HYBRID | 50 | 0 | 0.6 | 96 | 130 |
| Example 32 | 7528 | 16000 | 2864 | 86 | STEEL | 33.3 | 0 | 0.8 | 93 | 143 |
| Example 33 | 750 | 2143 | 2700 | 54 | HYBRID | 50 | −10 | 1.4 | 108 | 130 |
| Example 34 | 908 | 2143 | 2700 | 54 | HYBRID | 30 | 0 | 2 | 96 | 130 |
| Comparative | 42 | 2143 | 2700 | 54 | HYBRID | 50 | −20 | 7.3 | 94 | 168 |
| Example 34 | | | | | | | | | | |
| Comparative | 1514 | 2143 | 2700 | 54 | HYBRID | 50 | −30 | 15 | 92 | 170 |
| Example 35 | | | | | | | | | | |
| Comparative | 1514 | 2143 | 2700 | 54 | HYBRID | 50 | −40 | 21 | 95 | 180 |
| Example 36 | | | | | | | | | | |

As shown in Table 3, first, in Example 30 to Example 34, the treat tensile rigidity of one belt layer is 750 kgf/mm2 or more, and thus, it was verified that lowering of steering stability is restrained. Second, in Example 30 to Example 34, the rigidity of one belt cord (the cord rigidity) is 526 kgf or more/mm2 or more, and thus, it was verified that lowering of steering stability is restrained. Third, in Example 30 to Example 34, the treat tensile strength of the belt layer per width of 50 mm is 2,100 kgf or more, and thus, it was verified that lowering of fracture strength is restrained. Fourth, in Example 30 to Example 34, the strength of one belt cord (the cord strength) is 50 kgf or more, and thus, it was verified that lowering of fracture strength is restrained. Fifth, in Example 30 to Example 34, the inclination of the belt cord with respect to the tire circumferential direction is in the range of −10 degrees or more and 0 degree or less, and thus, it was verified that the internal pressure growth @ center is restrained. Six, in Example 30 to Example 34, the number of spikes of the belt cord per width of 50 mm is in the range of 30 to 65, and thus, it was verified that lowering of steering stability is restrained.

In addition, in Example 30 to Example 34, it was verified that a good result is obtained as to the internal pressure growth @ center, and a good result is also obtained as to the fracture strength.

On the other hand, in Comparative Examples 31 and 32 and Comparative Example 34, the treat tensile rigidity of one belt layer is smaller than 750 kgf/mm2, and thus, it was verified that steering stability lowers. In addition, in Comparative Examples 31 to 33, the treat tensile strength of the belt layer per width of 50 mm is smaller than 2,100 kgf, and thus, it was verified that the fracture strength remarkably lowers.

Further, in Comparative Examples 34 to 36, the inclination of the belt cord with respect to the tire circumferential direction is out of the range of −10 degree or more and 0 degree or less, and thus, it was verified that a good result is not obtained as to the internal pressure growth @ center.

In addition, in Comparative Example 31 and Comparative Example 32, it was verified that a good result is not obtained as to the internal pressure growth @ center, and a good result is not obtained as to the fracture strength as well.

[Evaluation Result 4]

Hereinafter, Evaluation Result 4 will be described. In Evaluation Result 4, as shown in Table 4, there were prepared tires which are different from each other in terms of the overlap width of the carcass layers folded back at the bead core (an overlap width) in the tire width direction. It is to be noted that with respect to the overlap width of the carcass layers, a percentage of the overlap width of the carcass layers with respect to the belt layer in the tire width direction is represented by %. An index evaluation was subjectively made as to the steering stability by means of a cruising test of a vehicle by mounting these tires to the vehicle. It is to be noted that the index 100 is an index of steering stability corresponding to the tire in which no carcass layer is overlapped in the tread portion and in which no belt layer is eliminated. In addition, the molding properties and weights of these tires were evaluated. It is to be noted that in Examples and Comparative Examples, the tires having a similar structure to that of the embodiments are employed except the values shown in Table 4. In addition, the tire size used is “155/65R13”.

TABLE 4

| | Overlap width of | Steering | | |
|---|---|---|---|---|
| | carcass layer | stability | Molding | |
| | (against belt layer) | Cp (INDEX) | property | Weight |
| Comparative | 10% | 66 | X | ◯ |
| Example 41 | | | | |
| Example 40 | 30% | 96 | ◯ | ◯ |
| Example 41 | 50% | 100 | ◯ | ◯ |
| Comparative | 100% | 106 | ◯ | X |
| Example 42 | | | | |

As shown in Table 4, in Examples 40 and 41, the overlap width of the carcass layers with respect to the belt layer is 30% or more, and thus, it was verified that lowering of steering stability is restrained. In addition, it was verified that good results are obtained as to the molding properties and weights of the tires as well.

On the other hand, in Comparative Example 41, the overlap width of the carcass layers with respect to the belt layer is smaller than 30%, and thus, it was verified that steering stability remarkably lowers. In addition, it was verified that a good result is not obtained as to the molding properties of the tires. In Comparative Example 42, the overlap width of the carcass layers with respect to the belt layer is 100%, and thus, it was verified that a good result is not obtained as to the weights of the tires.

[Evaluation Result 5]

Hereinafter, Evaluation Result 5 will be described. In Evaluation Result 5, as shown in Table 5, there were prepared a tire with one belt layer and a tire with two belt layers in the tire width direction. It is to be noted that the tire with two belt layers is assumed to have a first belt layer and a second belt layer that is disposed so as to be outer in tire radial direction than the first belt layer. Hereinafter, a description will be given, assuming that an inclination with respect to the tire circumferential direction (the equator centerline CL) of a plurality of belt cords in the first belt layer is a first inclination. On the other hand, a description will be given, assuming that an inclination with respect to the tire circumferential direction (the equator centerline CL) of a plurality of belt cords in the second belt layer is a second inclination. In addition, in Evaluation Result 5, tires which are different from each other in terms of the angle of the first inclination were prepared.

In addition, steering stabilities of these tires were evaluated by index by employing a testing instrument for a flat belt system. It is to be noted that the index 100 is an index of steering stability corresponding to the tires in which no carcass layer is overlapped in the tread portion and in which no belt layer is eliminated. In addition, the molding properties and weights of these tires were evaluated. It is also to be noted that in Examples and Comparative Examples, the tires having a similar structure to that of the embodiments are employed except the values shown in Table 5. In addition, the tire width used is “255/45R17”.

TABLE 5

| | | | | | Steering |
|---|---|---|---|---|---|
| | Structure | Angle of | Angle of | | stability |
| | of | first | second | Weight | Cp |
| | belt layer | belt layer | belt layer | (INDEX) | (INDEX) |
| Comparative | One | — | 0 | 83 | 86 |
| Example 51 | layer | | | | |
| Comparative | Two | −10 | 0 | 87 | 88 |
| Example 52 | layers | | | | |
| Comparative | Two | 0 | 0 | 87 | 88 |
| Example 53 | layers | | | | |
| Example 51 | Two | 10 | 0 | 87 | 91 |
| | layers | | | | |
| Example 52 | Two | 20 | 0 | 87 | 94 |
| | layers | | | | |
| Example 53 | Two | 30 | 0 | 87 | 92 |
| | layers | | | | |
| Example 54 | Two | 40 | 0 | 87 | 89 |
| | layers | | | | |
| Example 55 | Two | 50 | 0 | 87 | 86 |
| | layers | | | | |

As shown in Table 5, in Example 51 to Example 54, the angle of the first inclination is larger than the angle of the second inclination, and thus, it was verified that lowering of steering stability is restrained. In addition, it was verified that a good result is obtained as to the weight of the tire as well. It is to be noted that in Example 55, a predetermined advantageous effect is attained as to the weight of the tire, whereas an advantageous effect is low as to steering stability. Namely, it was verified that if the angle of the first inclination is an angle of 10 degrees or more and 40 degrees or less, a good result is obtained as to each of the steering stability and the weight of the tire.

On the other hand, in Comparative Example 51 to Comparative Example 53, the angle of the first inclination is equal to or smaller than the angle of the second inclination, and thus, it was verified that an advantageous effect of restraining steering stability lowers.

### Other Embodiments

The present invention has been described according to the aforementioned embodiments. However, it must not be understood that the discussions and the drawings constituting a part of this disclosure limit the present invention. From this disclosure, various alternative embodiments, examples and operational techniques are apparent to those skilled in the art.

Note that the entire content of the Japanese Patent Application No. 2011-118163 (filed on May 26, 2011) is incorporated herein by reference.

### INDUSTRIAL APPLICABILITY

As described above, the present invention can provide a tire that is capable of reducing at least one belt layer of a plurality of belt layers while ensuring a rigidity with respect to a shear stress in a tire width direction.

1. A tire comprising one pair of bead cores, a carcass layer having a toroidal shape that extends between said one pair of bead cores, and a belt layer disposed so as to be adjacent to the carcass layer, wherein
the carcass layer is folded back to an outside in a tire width direction at the bead core,
the carcass layer folded back at the bead core is disposed so as to be overlapped in a tread portion having a tire stepping surface, and
the carcass layer is formed of a plurality of carcass cords, each of which has an inclination of 30 degrees or more and 50 degrees or less with respect to a tire circumferential direction.

2. The tire according to claim 1, wherein in a direction in which the carcass cords extend, a treat tensile rigidity of the carcass layer is 90 kgf/mm2 or more and 300 kgf/mm2 or less.

3. The tire according to claim 1, wherein in a tire width direction, an overlap width of the carcass layer that is folded back at the bead core is ⅓ or more of a width of the belt layer.

4. The tire according to claim 1, wherein the belt layer has a plurality of belt cords, each of which has an inclination of −10 degrees or more and 0 degree or less with respect to the tire circumferential direction,
in the tire circumferential direction, a treat tensile rigidity of the belt layer is 750 kgf/mm2 or more, and
a treat tensile strength per width of 50 mm is 2,100 kgf or more.

5. A pneumatic tire according to claim 1, having a first belt layer and a second belt layer as the belt layer, the second belt layer being disposed so as to be adjacent to the first belt layer in a tire radial direction, wherein
the second belt layer has a plurality of belt cords, each of which has a predetermined inclination with respect to the tire circumferential direction, and
the first belt layer has a plurality of belt cords, each of which has an inclination that is larger than the predetermined angle with respect to the tire circumferential direction.
